(19) United States
(12) Patent Application Publication
(10) Pub. No.: US 2011/0216341 A1
(43) Pub. Date: Sep. 8, 2011

(54) IMAGE PROCESSING DEVICE AND IMAGE PROCESSING METHOD

(75) Inventor: Akihiro Moro, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/040,517

(22) Filed: Mar. 4, 2011

Related U.S. Application Data
(60) Provisional application No. 61/311,549, filed on Mar. 8, 2010.

(51) Int. Cl. G06F 3/12

(52) U.S. Cl. 358/1.13

(57) ABSTRACT

According to one embodiment, an image processing device includes a storage unit, a reading unit, a data processing unit, and a display unit. The storage unit stores registered user identification information and a registered printing parameter. The reading unit reads printing data from a memory device. The data processing unit processes the printing data based on the registered printing parameter in response to detection of input user identification information corresponding to the registered user identification information. The display unit displays a first printing image corresponding to first process completion printing data which is processed using the registered printing parameter.

### CROSS-REFERENCE TO RELATED APPLICATIONS

This application is based upon and claims the benefit of priority from U.S. Provisional Application No. 61/311,549, filed on Mar. 8, 2010; the entire contents of which are incorporated herein by reference.

### FIELD

Embodiments described herein relate generally to an image processing device and an image processing method.

### BACKGROUND

In recent years, an image processing device (for example, a digital copier) having a USB memory device connector appears. For example, such a digital copier supports USB direct printing. Using the USB direct printing function, the digital copier can be connected to a USB memory via the USB memory device connector and print images based on files stored in the USB memory device. In other words, the digital copier determines to which file of a PDF file, an XPS file, a JPEG file, a PRN file, and a PS file, a file stored in the USB memory corresponds, from the file extension stored in the USB memory device, and prints an image based on the file stored in the USB memory device on the basis of the determination result.

For example, in response to designation of a printing mode from a user, the digital copier changes operation mode to a printing mode, and further, in response to designation of a USB memory device by the user, reads a plurality of files stored in the USB memory device, and displays the plurality of files in a list. In addition, the copier prints an image based on a selected file in response to selection of a file by the user.

When the digital copier cannot access a network environment, that is, a computer connected to a network cannot instruct the digital copier to perform printing, the above-described USB direct printing is convenient.

In addition, When a password is set in a file (for example, a PDF file) stored in the USB memory device, the copier requests the user to input the password, and, in response to the password input from the user, prints an image based on the file stored in the USB memory device.

### BRIEF DESCRIPTION OF THE DRAWINGS

FIG. 1 is a block diagram illustrating an example of an image processing device (for example, a digital copier) according to an embodiment.

FIG. 2 is a diagram illustrating a display example of a first printing designation screen on a display unit of a control panel of the image processing device.

FIG. 3 is a diagram illustrating a display example of a third printing designation screen on the display unit of the control panel of the image processing device.

FIGS. 4A and 4B are flowcharts illustrating an example of an image process in the image processing device.

FIG. 5 is a diagram illustrating a display example of a printing stand-by list screen on the display unit of the control panel of the image processing device.

FIG. 6 is a diagram illustrating a display example of an image quality adjustment screen on the display unit of the control panel of the image processing device.

FIG. 7 is a diagram illustrating a display example of a fourth printing designation screen on the display unit of the control panel of the image processing device.

### DETAILED DESCRIPTION

In general, according to one embodiment, an image processing device includes a storage unit, a reading unit, a data processing unit, and a display unit. The storage unit stores registered user identification information and a registered printing parameter. The reading unit reads printing data from a memory device. The data processing unit processes the printing data based on the registered printing parameter in response to detection of input user identification information corresponding to the registered user identification information. The display unit displays a first printing image corresponding to first process completion printing data which is processed using the registered printing parameter.

Hereinafter, embodiments will be described.

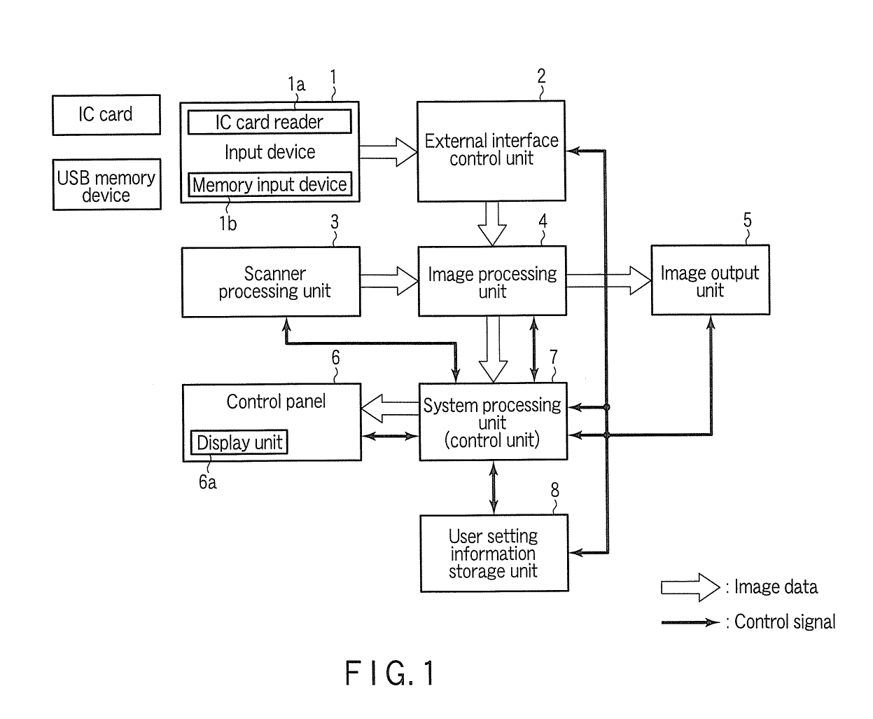

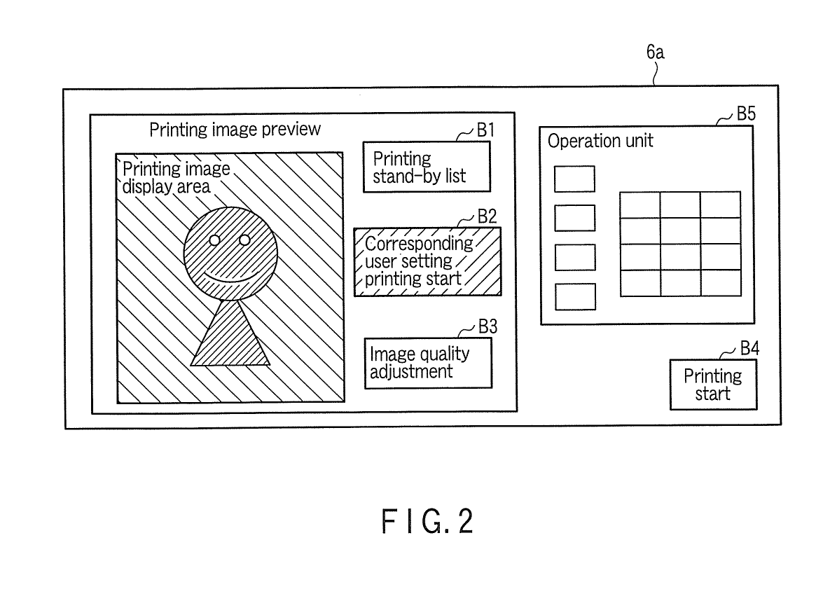

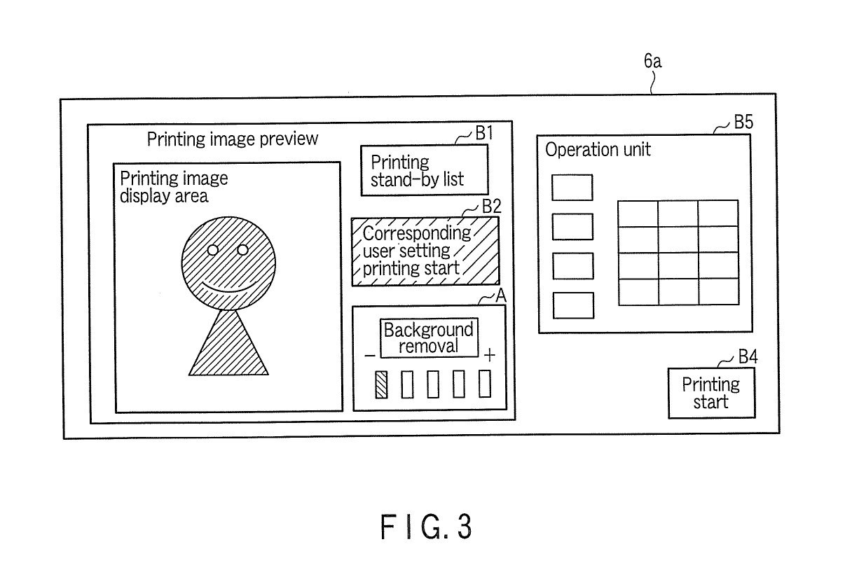

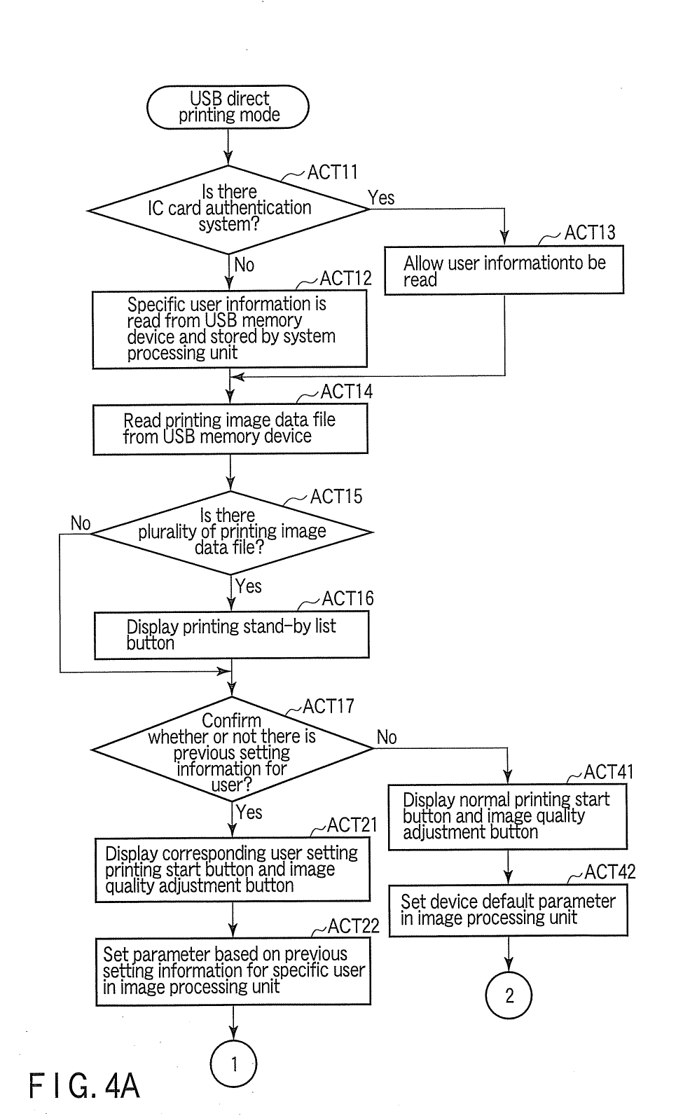

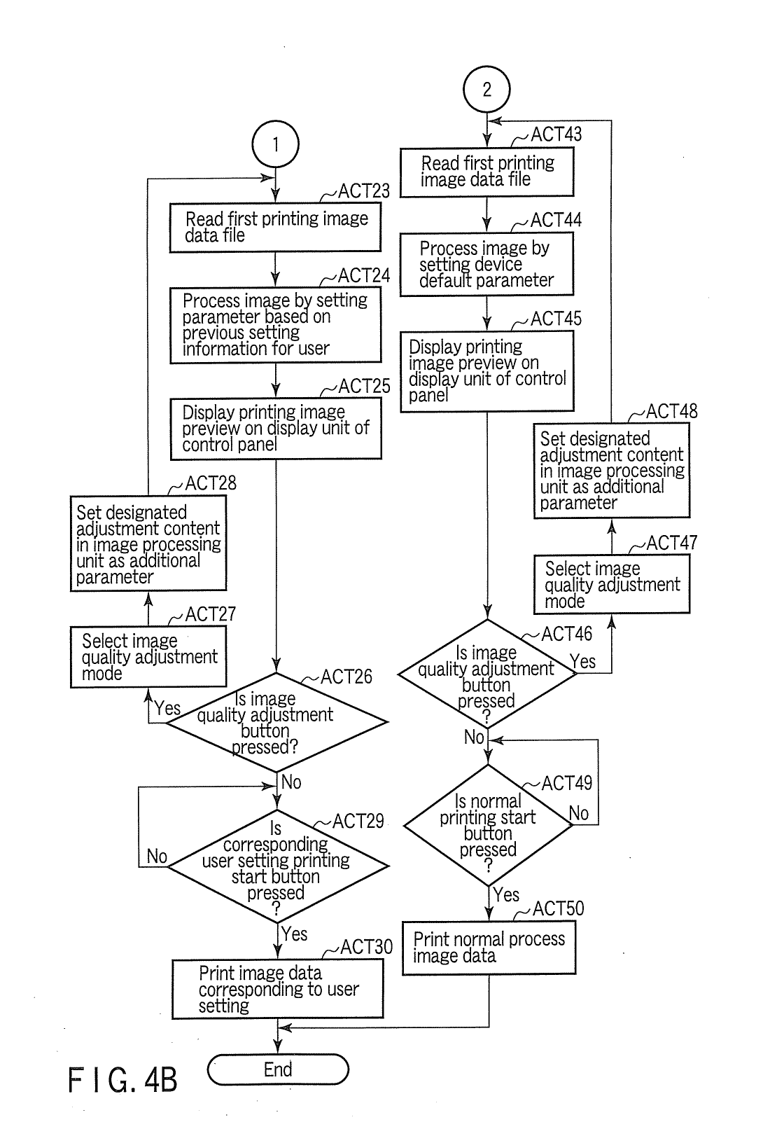

FIG. 1 is a block diagram illustrating an example of an image processing device (for example, a digital copier) according to an embodiment. FIGS. 2 and 3 are diagrams illustrating display examples on a display unit of a control panel of the image processing device. FIGS. 4A and 4B are flowcharts illustrating an example of an image process (for example, a USB direct printing process) in the image processing device.

As shown in FIG. 1, the image processing device includes an input device 1, an external interface control unit 2, a scanner processing unit 3, an image processing unit 4, an image output unit 5, a control panel 6, a system processing unit (control unit) 7, and a user setting information storage unit 8.

The input device 1 includes an IC card reader 1a and a memory input device 1b. The IC card reader 1a reads data stored in an IC card (information storage medium). The memory input device 1b reads data (files) stored in various kinds of memories, such as a USB memory device.

The control panel 6 includes a display unit 6a. For example, the display unit 6a can display in full color at high resolution, includes an operation input device such as a touch panel, and detects that displayed contents (displayed items and selected items) are selected. In addition, the control panel 6 includes an operation unit having a plurality of buttons in addition to the display unit 6a.

The scanner processing unit 3 reads a document image and obtains image data. The image processing unit 4 processes image data based on a printing parameter (or image quality adjustment parameter). The image output unit 5 forms an image based on the image data processed by the image processing unit 4.

First, an example of registration of user identification information and a printing parameter (or an image quality adjustment parameter) will be described.

For example, a user or an administrator can register user identification information and a printing parameter in the image processing device using the input device 1, the control panel 6 or the like. For example, the user or the administrator designates a user registration mode using the control panel 6 and screens the IC card reader 1a with an IC card storing user identification information. In response thereto, the IC card reader 1a reads the user identification information stored in the IC card, and the external interface control unit 2 stores the read user identification information (registered user identification information) in the user setting information storage unit 8. Thereafter, the display unit 6a of the control panel 6 requests registration of the printing parameter, and the display unit 6a displays a screen for registering the printing parameter. In response thereto, the user or the administrator inputs the printing parameter from the screen for registration on the control panel 6. The system processing unit 7 correlates the registered user identification information with the input printing parameter (registered printing parameter) and stores the result in the user setting information storage unit 8. In addition, the user setting information storage unit 8 stores a default printing parameter.

For example, the registered printing parameter is an image quality adjustment parameter set according to preference of a user for image quality. In other words, a user can obtain an image (printing image) adjusted to a desired image quality by processing printing image file data based on the registered printing parameter.

In addition, in the above description, although a user is registered using an IC card, user identification information stored in various kinds of memory devices may be registered using the various kinds of memory devices instead of the IC card, and user identification information input via the control panel 6 may be registered.

In addition, a password (registered password) may be registered using an IC card, various kinds of memory devices, or the control panel 6. In this case, the user setting information storage unit 8 correlates the registered user identification information, the registered printing parameter, and the registered password with one another, so as to be stored.

Next, an image process (for example, a USB direct printing process) in the image processing device will be described. In addition, although an example of the direct printing process using a USB memory is described in this embodiment, various kinds of memories other than USB memory may be used.

If a USB memory device is connected to the input device 1, the external interface control unit 2 detects the connection of the USB memory device, and the system processing unit 7 performs a memory direct printing mode in response to the detection of the connection of the USB memory device.

For example, if the image processing device (the input device 1) makes the IC card reader 1a connected thereto, and the image processing device (the system processing unit 7) is equipped with an IC card authentication system (ACT 11, YES), the system processing unit 7 performs an IC card authentication. In other words, the IC card reader 1a reads user identification information (input user identification information) stored in the IC card (ACT 13), and the system processing unit 7 compares registered user identification information stored in the user setting information storage unit 8 with the input user identification information so as to detect a correspondence relationship between the registered user identification information and the input user identification information. The system processing unit 7 determines the authentication as successful if the registered user identification information corresponds with the input user identification information. In contrast, the system processing unit 7 determines the authentication as failed if the registered user identification information does not correspond with the input user identification information.

In addition, if the image processing device (the system processing unit 7) is not mounted with the IC card authentication system (ACT 11, NO), for example, the input device 1 reads user identification information (input user identification information) stored in the USB memory device (ACT 12). The system processing unit 7 compares the registered user identification information stored in the user setting information storage unit 8 with the input user identification information, and detects a correspondence relationship between the registered user identification information and the input user identification information. The system processing unit 7 determines the authentication as successful if the registered user identification information corresponds with the input user identification information. In contrast, the system processing unit 7 determines the authentication as failed if the registered user identification information does not correspond with the input user identification information.

In addition, the input device 1 reads one or a plurality of printing image data files stored in the USB memory device (ACT 14). The external interface control unit 2 supplies the one or plurality of printing image data files read to the image processing unit 4 and notifies the system processing unit 7 of information regarding the one or plurality of printing image data files read.

The system processing unit 7 generates a first printing designation screen based on the successful authentication determination, and the display unit 6a of the control panel 6 displays the first printing designation screen. FIG. 2 is a diagram illustrating a display example of the first printing designation screen. Here, the generation of the first printing designation screen will be described.

If a plurality of printing image data files is read from the USB memory device (ACT 15), the system processing unit 7 generates first display information for displaying a printing stand-by list button (or a printing stand-by list key) B1 (ACT 16).

In addition, the system processing unit 7 generates second display information for displaying a corresponding user setting printing start button (or a corresponding user setting printing start key) B2 based on the successful authentication determination (ACT 17, YES), and generates third display information for displaying an image quality adjustment button (or an image quality adjustment key) B3 (ACT 21). The system processing unit 7 generates fourth display information for displaying a normal printing start button (or a normal printing start key) B4.

In addition, under a condition where the successful authentication determination is obtained, the system processing unit 7 instructs a registered printing parameter process in which a first printing image data file of one or a plurality of printing image data files read from the USB memory device, based on the registered printing parameter stored in the user setting information storage unit 8, and sets the registered printing parameter stored in the user setting information storage unit 8 in the image processing unit 4 (ACT 22). The image processing unit 4 reads the first printing image data file (ACT 23), processes first printing image data file using the registered printing parameter (ACT 24), generates first registered parameter process completion data, and generates a registered parameter process completion printing image corresponding to the first registered parameter process completion data. Also, the system processing unit 7 generates fifth display information for displaying (previewing) the registered parameter process completion printing image (ACT 25).

The display unit 6a of the control panel 6 displays a first printing designation screen including a printing stand-by list button B1, a corresponding user setting printing start button B2, an image quality adjustment button B3, a normal printing start button B4, and a registered parameter process completion printing image (preview), based on the first to fifth display information. For example, in order to increase operability, the display unit 6a displays the printing stand-by list button B1, the corresponding user setting printing start button B2, and the image quality adjustment button B3 so as to be correlated with the registered parameter process completion printing image (preview).

If the image quality adjustment button B3 in the first printing designation screen is not selected (ACT 26, NO) but the corresponding user setting printing start button B2 is selected (ACT 29, YES), the system processing unit 7 instructs an image to be formed based on the first registered parameter process completion data.

In other words, if the corresponding user setting printing start button B2 is selected, the system processing unit 7 instructs an image to be formed based on the registered printing parameter stored in the user setting information storage unit 8.

In response thereto, the image output unit 5 forms an image based on the first registered parameter process completion data (ACT 30). Thereby, the user can obtain an image adjusted to a desired image quality with a simple operation (simply by selecting the corresponding user setting printing start button B2) without a complicated operation (without a printing parameter setting process).

If the printing stand-by list button B1 is selected in the first printing designation screen shown in FIG. 2, the display unit 6a changes the display of the first printing designation screen to a display of the printing stand-by list screen. When a plurality of printing image data is read from the USB memory device, the system processing unit 7 generates the printing stand-by list screen including a plurality of printing image data file selection items (a plurality of file selection buttons) corresponding to the plurality of printing image data files based on information for the plurality of read printing image data files. In response thereto, the display unit 6a can display the printing stand-by list screen including the plurality of printing image data file selection items.

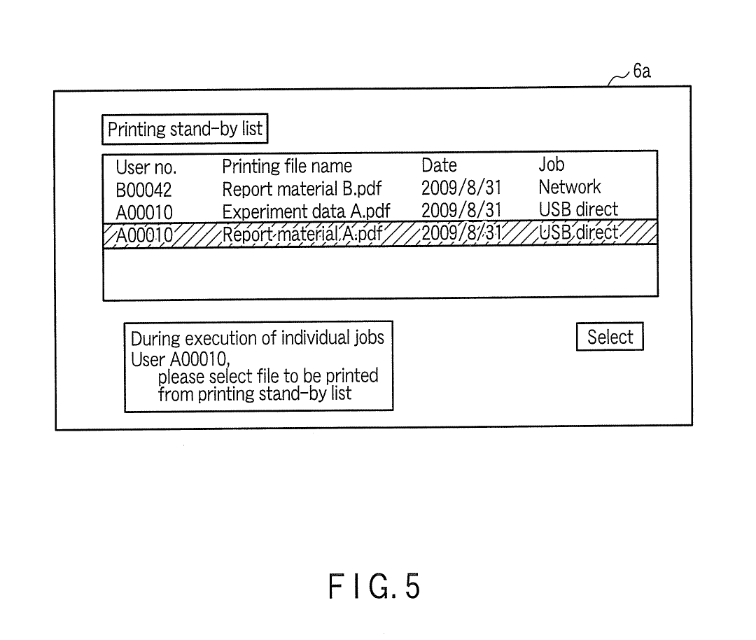

FIG. 5 is a diagram illustrating a display example of the printing stand-by list screen. For example, as shown in FIG. 5, the printing stand-by list screen includes a first selection item (a first selection key) for selecting a first printing image data file (experiment data A.pdf) having first user identification information A00010, and a second selection item (a second selection key) for selecting a second printing image data file (report material A.pdf) having second user identification information B00042.

The user can designate printing for the first printing image data file or the second printing image data file by selecting the first selection item (first selection key) or the second selection item (second selection key).

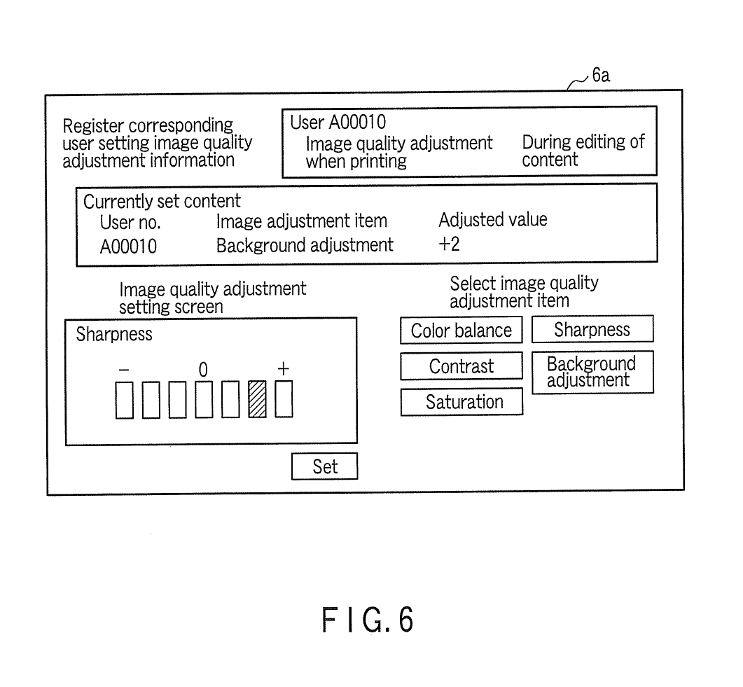

If the image quality adjustment button B3 is selected in the first printing designation screen shown in FIG. 2 (ACT 26, YES), the system processing unit 7 executes an image quality adjustment mode (ACT 27), and the display unit 6a changes the display of the first printing designation screen to a display of an image quality adjustment screen. FIG. 6 is a diagram illustrating a display example of the image quality adjustment screen.

The user can change, add, or delete a registered printing parameter (image quality adjustment parameter) through the image quality adjustment screen (ACT 28). The user can adjust the image quality adjustment parameter through the image quality adjustment screen. In other words, the user can adjust the image quality adjustment parameter which can be adjusted by a printer driver on a computer.

For example, the user can adjust (reset) sharpness, background, contrast, brightness, saturation, color balance, and the like through the image quality adjustment screen. FIG. 6 is a diagram illustrating an example of a sharpness adjustment through the image quality adjustment screen. The user may select sharpness adjustment through the image quality adjustment screen and increase the sharpness setting value.

In response to the completion of the image quality adjustment, the system processing unit 7 instructs reprocessing for processing the first printing image data file, based on the adjusted printing parameter, and sets the adjusted printing parameter in the image processing unit 4. The image processing unit 4 reads the first printing image data file, processes the first printing image data file using the adjusted printing parameter, generates first adjusted parameter process completion data, and generates an adjusted parameter process completion printing image corresponding to the first adjusted parameter process completion data. In addition, the system processing unit 7 generates sixth display information for displaying (previewing) the adjusted parameter process completion printing image.

The display unit 6a of the control panel 6 displays a second printing designation screen including the printing stand-by list button B1, the corresponding user setting printing start button B2, the image quality adjustment button B3, the normal printing start button B4, and the adjusted parameter process completion printing image (preview), based on the first, second, third, fourth, and sixth display information.

The system processing unit 7 may update the registered printing parameter stored in the user setting information storage unit 8 to the adjusted printing parameter automatically or according to an update designation from the user. Thereby, next time, the adjusted printing parameter is treated as a registered printing parameter.

In addition, as shown in FIG. 2, when the background of the registered parameter process completion printing image (preview) displayed on the first printing designation screen is excessively highlighted, the image quality adjustment may be performed. If the image quality adjustment button B3 in the first printing designation screen shown in FIG. 2 is selected, the system processing unit 7 executes an image quality adjustment mode, and the display unit 6a displays a simple image quality adjustment screen A (refer to FIG. 3) inside the first printing designation screen.

The user adjusts the registered printing parameter through the simple image quality adjustment screen A. For example, the user adjusts the background density through the simple image quality adjustment screen A. Specifically, the user can change a setting for increasing a density value for a light printing data part to a setting for decreasing it through the simple image quality adjustment screen A. In other words, the user can set the background removal level to a low value through the simple image quality adjustment screen A. In addition, the user can adjust the image quality adjustment parameter which can be adjusted by a printer driver on a computer through the simple image quality adjustment screen A.

In response thereto, the system processing unit 7 instructs reprocessing for processing the first printing image data file based on the adjusted printing parameter, and sets the adjusted printing parameter in the image processing unit 4. The image processing unit 4 reads the first printing image data file, processes the first printing image data file using the adjusted printing parameter, generates first adjusted parameter process completion data, and generates an adjusted parameter process completion printing image corresponding to the first adjusted parameter process completion data. In addition, the system processing unit 7 generates seventh display information for displaying (previewing) the adjusted parameter process completion printing image.

The display unit 6a of the control panel 6 displays a third printing designation screen including the printing stand-by list button B1, the corresponding user setting printing start button B2, the image quality adjustment button B3, the normal printing start button B4, and the adjusted parameter process completion printing image (preview), based on the first, second, third, fourth, and seventh display information. FIG. 3 is a diagram illustrating an example of the third printing designation screen.

As can be seen from the comparison between FIGS. 2 and 3, in FIG. 2, the background of the registered parameter process completion printing image (preview) is excessively highlighted (the background is blurred), but, in FIG. 3, the background of the adjusted parameter process completion printing image (preview) is naturally displayed (the background is not blurred).

The user views the registered parameter process completion printing image (preview) in the first printing designation screen shown in FIG. 2, and if not satisfied with the image quality and the like, selects the image quality adjustment button B3 in the first printing designation screen, thereby simply adjusting the image quality. In addition, the user can check an image quality adjustment state by viewing the adjusted parameter process completion printing image (preview) in the third printing designation screen shown in FIG. 3, and if not satisfied with the image quality yet, can adjust the image quality through the simple image quality adjustment screen A in the third printing designation screen. In other words, the user can repeat the adjustment until an arbitrary image quality is reached while checking the adjusted parameter process completion printing image (preview).

If the user is satisfied with the image quality and the like when viewing the registered parameter process completion printing image (preview) in the first printing designation screen shown in FIG. 2, the user can simply obtain the registered parameter process completion printing image only by selecting the corresponding user setting printing start button B2 in the first printing designation screen.

In addition, if the user is satisfied with the image quality and the like when viewing the adjusted parameter process completion printing image (preview) in the third printing designation screen shown in FIG. 3, the user can simply obtain the adjusted parameter process completion printing image only by selecting the corresponding user setting printing start button B2 in the third printing designation screen.

The system processing unit 7 may update the registered printing parameter stored in the user setting information storage unit 8 to the adjusted printing parameter automatically or according to an update designation from the user. Thereby, next time, the adjusted printing parameter is treated as a registered printing parameter.

In addition, the input device 1 of the image processing device may read the first printing image data file from the USB memory device when image quality is adjusted, or the image processing unit 4 of the image processing device may first store the first printing image data file read from the USB memory device in a memory of the image processing unit 4, and when image quality is adjusted, the first printing image data file may be read from the memory.

In the above description, the image process based on the successful authentication determination is described, and, an image process based on the failed authentication determination will be described below.

Based on the failed authentication determination (ACT 17, NO), the system processing unit 7 generates third display information for displaying the image quality adjustment button (or an image quality adjustment key) B3 and generates fourth display information for displaying the normal printing start button (or printing start key) B4 (ACT 41).

In addition, under a condition where the failed authentication determination is obtained, the system processing unit 7 instructs a default printing parameter process in which a first printing image data file of one or a plurality of printing image data files read from the USB memory device, based on the default printing parameter stored in the user setting information storage unit 8, and sets the default printing parameter stored in the user setting information storage unit 8 in the image processing unit 4 (ACT 42). The image processing unit 4 reads the first printing image data file (ACT 43), processes first printing image data file using the default printing parameter (ACT 44), generates first default parameter process completion data, and generates a default parameter process completion printing image corresponding to the first default parameter process completion data. Also, the system processing unit 7 generates eighth display information for displaying (previewing) the default parameter process completion printing image (ACT 45).

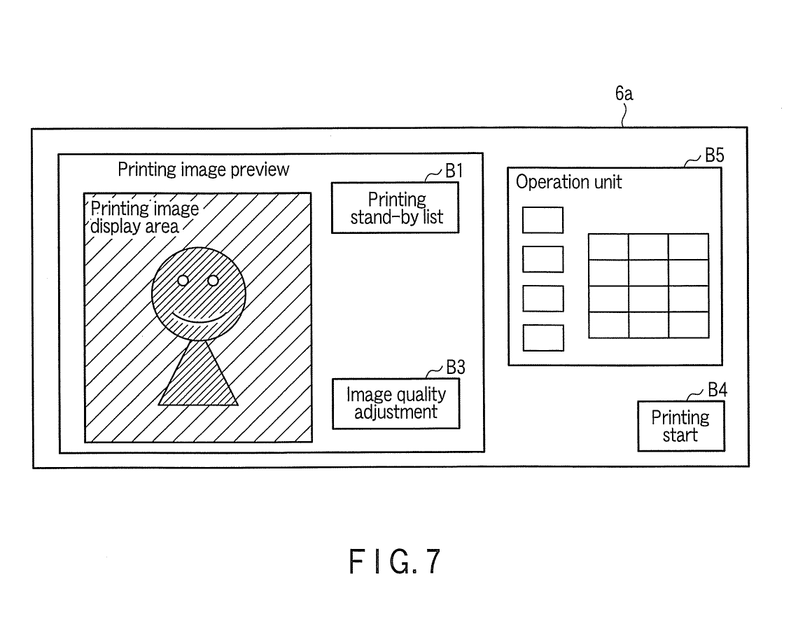

The display unit 6a of the control panel 6 displays a fourth printing designation screen including the printing stand-by list button B1, the image quality adjustment button B3, the normal printing start button B4, and a default parameter process completion printing image (preview), based on the first, third, fourth, and eighth display information. FIG. 7 is a diagram illustrating a display example of the fourth printing designation screen. For example, in order to increase operability, the display unit 6a displays the printing stand-by list button B1, and the image quality adjustment button B3 so as to be correlated with the default parameter process completion printing image (preview).

If the image quality adjustment button B3 in the fourth printing designation screen is not selected (ACT 46, NO) but the normal printing start button B4 is selected (ACT 49, YES), the system processing unit 7 instructs an image to be formed based on the first default parameter process completion data. In other words, if the normal printing start button B4 is selected, the system processing unit 7 instructs an image to be formed based on the default printing parameter stored in the user setting information storage unit 8. In response thereto, the image output unit 5 forms an image based on the first default parameter process completion data (ACT 50). Thereby, the user can obtain an image adjusted to the default image quality.

If the printing stand-by list button B1 is selected in the fourth printing designation screen shown in FIG. 7, the display unit 6a changes the display of the fourth printing designation screen to a display of the printing stand-by list screen. The printing stand-by list screen is the same as described above.

If the image quality adjustment button B3 is selected in the fourth printing designation screen shown in FIG. 7 (ACT 46, YES), the system processing unit 7 executes an image quality adjustment mode (ACT 47), and the display unit 6a changes the display of the fourth printing designation screen to a display of an image quality adjustment screen. The image quality adjustment screen is the same as described above.

Next, an enlargement display and a reduction display of each printing image preview will be described. The display unit 6a displays an operation unit B5 having various kinds of button. For example, the operation unit B5 includes a same size display button, an enlargement display button, a reduction display button, and a magnification changing button. In addition, the operation unit B5 may be an operation unit including a plurality of hard buttons provided on the control panel outside the display unit 6a.

When the same size display button is selected, the display unit 6a displays the printing image preview at the printing size. In addition, when the enlargement display button is selected, the display unit 6a displays the printing image preview so as to be enlarged. Also, when the reduction display button is selected, the display unit 6a displays the printing image preview so as to be reduced. Further, when the magnification changing button is selected and the magnification is designated, the display unit 6a displays the printing image preview at the designated magnification. Thereby, for example, the user can enlarge a portion of an image they are interested in and adjust the image quality of the image.

Next, customization of each button displayed on the display unit 6a will be described. The display unit 6a displays the operation unit B5 having various kinds of buttons. For example, the operation unit B5 includes a screen setting button.

When the screen setting button is selected, the display unit 6a displays items such as, for example, a button size setting item, a button color setting item, a button shape setting item, a button display position setting item, and a preview display setting item.

When a button and a button size are designated using the button size setting item, the display unit 6a displays the designated button at the designated size. In addition, when a button and a button color are designated using the button color setting item, the display unit 6a displays the designated button with the designated color. Also, when a button and a button shape are designated using the button shape setting item, the display unit 6a displays the designated button with the designated shape. Further, when a button and a button display position are designated using the button display position setting item, the display unit 6a displays the designated button at the designated display position. In addition, when a preview display size and a preview display position are designated using the preview display setting item, the display unit 6a displays a preview at the designated preview display size and the designated preview display position.

Thereby, the user can change the display of each button according to preference, and can change the preview display according to preference.

For example, FIG. 2 also shows a display example of the first printing designation screen which is customized by the user. As shown in FIG. 2, the corresponding user setting printing start button B2 is displayed to be larger than other buttons. Thereby, the corresponding user setting printing start button B2 can be easily recognized as compared with other buttons.

In the above description, although the case where the display unit 6a displays each button was described, for example, the normal printing start button B4 may be a hard button, or the normal printing start button B4 may be provided on the control panel 6 outside the display unit 6a.

For example, when an authentication is determined as successful, if the normal printing start button B4 is selected, the system processing unit 7 instructs an image to be formed based on the default printing parameter stored in the user setting information storage unit 8. In response thereto, the image output unit 5 forms an image based on the first default parameter process completion data. Thereby, even when the authentication is determined as successful, the user can obtain an image adjusted to default image quality. In other words, when the user does not want image quality to be automatically adjusted based on the registered printing parameter, the user can obtain an image adjusted to default image quality by selecting the normal printing start button B4.

Next, changing of the on and off states of the printing image preview will be described. The display unit 6a displays the operation unit B5 having various kinds of buttons. For example, the operation unit B5 includes a changing button which changes the on and off states of the printing image preview.

When the changing button is selected, the on and off states of the printing image preview are changed. For example, if the printing image preview is set to the on state, the printing image preview is displayed as described above. In contrast, if the printing image preview is set to the off state, the printing image preview is not displayed.

Next, a case where a printing image data file stored in the USB memory device is locked by a password (a registered password stored in the user setting information storage unit 8) or a case where a printing image data file stored in the USB memory device is encrypted by a password (a registered password stored in the user setting information storage unit 8) will be described.

The input device 1 reads a printing image data file stored in the USB memory device, and the external interface control unit 2 supplies the printing image data file to the image processing unit 4 and notifies the system processing unit 7 of information regarding the encrypted printing image data file.

Based on the above-described successful authentication determination, the system processing unit 7 instructs the printing image data file to be processed by a registered password stored in the user setting information storage unit 8. The image processing unit 4 unlocks the printing image data file using the registered password. Alternatively, the image processing unit 4 decodes the printing image data file using the registered password. Thereby, even if the user does not input a password, the image processing device unlocks the printing image data file or decodes the printing image data file using the registered password and thus can form an image based on the printing image data file.

Hereinafter, an operation and an effect of the embodiment will be summarized.

As described above, the display unit 6a of the control panel 6 in the image processing device according to the embodiment displays the printing image preview before printing. For example, when the authentication is determined as successful, the display unit 6a displays the printing image preview based on image data processed by the registered printing parameter, and displays the image quality adjustment button B3 so as to correspond to the printing image preview.

In addition, when the authentication is determined as failed, the display unit 6a displays the printing image preview based on image data processed by the default printing parameter, and displays the image quality adjustment button B3 so as to correspond to the printing image preview.

Therefore, when the authentication is determined as successful, without performing a special operation, the user can check the printing image preview based on image data processed by the registered printing parameter, adjust the image quality using the image quality adjustment button B3, and designate printing using the corresponding user setting printing start button B2 after checking for satisfactory image quality. Thereby, it is possible to reduce wasted printing.

In addition, even when the authentication is determined as failed, without performing a special operation, the user can adjust the image quality using the image quality adjustment button B3 while checking the printing image preview based on image data processed by the default printing parameter, and designate printing using the normal printing start button B4 after checking for satisfactory image quality. Thereby, it is possible to reduce wasted printing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a storage unit that stores registered user identification information and a registered printing parameter;
a reading unit that reads printing data from a memory device;
a data processing unit that processes the printing data based on the registered printing parameter in response to detection of input user identification information corresponding to the registered user identification information; and
a display unit that displays a first printing image corresponding to first process completion printing data which is processed using the registered printing parameter.

2. The device according to claim 1, wherein the storage unit stores a default printing parameter,
wherein the data processing unit processes the printing data based on the default printing parameter in response to the input user identification information corresponding to the registered user identification information not being detected, and
wherein the display unit displays a second printing image corresponding to second process completion printing data which is processed using the default printing parameter.

3. The device according to claim 2, further comprising a changing button that receives an instruction for changing the registered printing parameter to a changed printing parameter,
wherein the data processing unit processes the printing data based on the changed printing parameter in response to the instruction for changing which is received through the changing button, and
wherein the display unit displays a third printing image corresponding to third process completion printing data which is processed using the changed printing parameter.

4. The device according to claim 3, wherein the display unit changes the first printing image display to the third printing image display in response to the instruction for changing which is received through the changing button.

5. The device according to claim 3, wherein the display unit display the changing button when the first printing image is displayed.

6. The device according to claim 1, further comprising an image forming unit that forms an image based on the first process completion printing data.

7. The device according to claim 6, further comprising a first image forming button that receives a first image forming instruction based on the first process completion printing data,
wherein the image forming unit forms an image based on the first process completion printing data in response to the first image forming instruction.

8. The device according to claim 7, wherein the display unit displays the first image forming button when the first printing image is displayed.

9. The device according to claim 2, further comprising an image forming unit that forms an image based on the first or the second process completion printing data.

10. The device according to claim 9, further comprising:
a first image forming button that receives a first image forming instruction based on the first process completion printing data; and
a second image forming button that receives a second image forming instruction based on the second process completion printing data,
wherein the image forming unit forms an image based on the first process completion printing data in response to the first image forming instruction, and forms an image based on the second process completion printing data in response to the second image forming instruction.

11. The device according to claim 10, wherein the display unit displays the first image forming button when the first printing image is displayed.

12. The device according to claim 3, further comprising an image forming unit that forms an image based on the first, the second, or third process completion printing data.

13. The device according to claim 12, further comprising:
a first image forming button that receives a first image forming instruction based on the first process completion printing data; and
a second image forming button that receives a second image forming instruction based on the second process completion printing data,
a third image forming button that receives a third image forming instruction based on the third process completion printing data,
wherein the image forming unit forms an image based on the first process completion printing data in response to the first image forming instruction, forms an image based on the second process completion printing data in response to the second image forming instruction, and forms an image based on the third process completion printing data in response to the third image forming instruction.

14. The device according to claim 13, wherein the display unit displays the first image forming button when the first printing image is displayed, and displays the third image forming button when the third printing image is displayed.

15. The device according to claim 1, further comprising a user identification information processing unit that reads the input user identification information from an information storage medium, compares the registered user identification information with the input user identification information, and detects the input user identification information corresponding to the registered user identification information.

16. The device according to claim 1, further comprising a user identification information processing unit that reads the input user identification information from the memory device, compares the registered user identification information with the input user identification information, and detects input user identification information corresponding to the registered user identification information.

17. The device according to claim 1, further comprising an enlargement and reduction button that receives an enlargement display instruction and a reduction display instruction,
wherein the display unit displays the first printing image so as to be enlarged in response to the enlargement display instruction, and displays the first printing image so as to be reduced in response to the reduction display instruction.

18. The device according to claim 8, further comprising a changing reception unit that receives an instruction for changing at least one of sizes, colors, shapes, and positions of the first image forming button,
wherein the display unit displays the first image forming button based on the changing instruction received by the changing reception unit.

19. The device according to claim 1, further comprising a display setting unit that receives settings for display or non-display of the first printing image,
wherein the display unit displays the first printing image based on the display setting received by the display setting unit, and does not display the first printing image based on the non-display setting received by the display setting unit.

20. An image processing method comprising:
reading printing data from a memory device;
processing the printing data based on a registered printing parameter in response to detection of input user identification information corresponding to the registered user identification information; and
displaying a first printing image corresponding to first process completion printing data which is processed using the registered printing parameter.
